(19) United States
(12) Patent Application Publication
(10) Pub. No.: US 2017/0306789 A1
(43) Pub. Date: Oct. 26, 2017

(54) METHOD FOR DETERMINING ANGULAR POSITIONS OF MULTIPLE COMPRESSOR GUIDE VANES

(71) Applicant: Siemens Aktiengesellschaft, Muenchen (DE)

(72) Inventors: Ow LAU, Shanghai (CN); Chao REN, Shanghai (CN); Thomas WALLSTAB, Muelheim (DE)

(73) Assignee: Siemens Aktiengesellschaft, Muenchen (DE)

(21) Appl. No.: 15/513,359

(22) PCT Filed: Nov. 4, 2014
(86) PCT No.: PCT/CN2014/090253

§ 371 Date: Mar. 22, 2017

(51) Int. Cl. F01D 21/00; F01D 9/04; G01B 11/14; G01B 17/00

(52) U.S. Cl. CPC F01D 21/003; G01B 17/00; F01D 9/041; G01B 11/14; F05D 2260/30

(57) ABSTRACT

A method is for determining the angular positions of multiple compressor guide vanes. The method includes measuring the positions of at least two points on the circumference of the actuating ring, via at least two linear position sensors fixed on the compressor casing, and pointing at the actuating ring vertically at a time when the actuating ring deviates from its original position where the ring center coincides with the casing center; calculating the ring center offset based on the measured positions of the at least two points and the radius of the actuating ring; measuring the angle of one of the multiple guide vanes at the same time when measuring the positions of the at least two points; and calculating the angles of the multiple guide vanes based on the ring center offset and the angle of the guide vane. An actuation apparatus for multiple compressor guide vanes is included.

### PRIORITY STATEMENT

This application is the national phase under 35 U.S.C. §371 of PCT International Application No. PCT/CN2014/090253 which has an International filing date of Nov. 4, 2014, which designated the United States of America, the entire contents of which are hereby incorporated herein by reference.

### FIELD

An embodiment of the invention relates in general to compressors of turbo machinery and more particularly to compressor guide vanes.

### BACKGROUND

Multiple guide vans are configured in compressors of turbo machinery, such as gas turbines, steam turbines and hydro turbines, for modulating air flowing into the compressors by changing their angular positions to adapt to various working conditions of the turbo machinery. The guide vanes are positioned around a circumference of an actuating ring and coupled with the actuating ring via levers. The actuating ring sits on a casing of the compressor via bearings attached to the casing. The actuating ring is actuated by pushrods to move along the circumference of the casing. The actuating ring, in turn, drives the guide vanes to rotate so that the angular positions of the guide vanes are modulated.

### SUMMARY

One embodiment of the invention is directed to a method for determining the angular positions of multiple compressor guide vanes, wherein the multiple compressor guide vanes are coupled with levers, the levers are coupled with an actuating ring which sits on a casing of the compressor and is movable around the circumference of the compressor casing, and the guide vanes are rotatable as the actuating ring moves around the circumference of the compressor casing, the method comprising: (a) measuring the positions of at least two points on the circumference of the actuating ring by at least two linear position sensors fixed on the compressor casing and pointing at the actuating ring vertically at a time when the actuating ring deviates from its original position where the ring center coincides with the casing center; (b) calculating the ring center offset based on the measured positions of the at least two points and the radius of the actuating ring; (c) measuring the angle of one of the multiple guide vane at the same time when measuring the positions of the at least two points; and (d) calculating the angles of the multiple guide vanes based on the ring center offset and the angle of the guide vane.

Another embodiment of the invention is directed to a method for determining the angle deviation of multiple compressor guide vanes, wherein the multiple compressor guide vanes are coupled with levers, the levers are coupled with an actuating ring which sits on a casing of the compressor and is movable around the circumference of the compressor casing, and the guide vanes are rotatable as the actuating ring moves around the circumference of the compressor casing, the method comprising: (a) measuring the positions of at least two points on the circumference of the actuating ring by at least two linear position sensors fixed on the compressor casing and pointing at the actuating ring vertically at a time when the actuating ring deviates from its original position where the ring center coincides with the casing center; (b) calculating the ring center offset based on the measured positions of the at least two points and the radius of the actuating ring; (c) measuring the angle of one of the multiple guide vane at the same time when measuring the positions of the at least two points; (d) calculating the angles of the multiple guide vanes based on the ring center offset and the angle of the guide vane; and (e) calculating the maximum vane angle deviation as the differential of the maximum angle and the minimum angle of the multiple guide vanes.

Another embodiment of the invention is directed to a method for determining the angle deviation of multiple compressor guide vanes, wherein the multiple compressor guide vanes are coupled with levers, the levers are coupled with an actuating ring which sits on a casing of the compressor and is movable around the circumference of the compressor casing, and the guide vanes are rotatable as the actuating ring moves around the circumference of the compressor casing, the method comprising: (a) measuring the positions of at least two points on the circumference of the actuating ring by at least two linear position sensors fixed on the compressor casing and pointing at the actuating ring vertically at a time when the actuating ring deviates from its original position where the ring center coincides with the casing center; (b) calculating the ring center offset based on the measured positions of the at least two points and the radius of the actuating ring; and (c) calculating the maximum vane angle deviation based on the ring center offset.

Another embodiment of the invention is directed to a method for controlling the angular positions of multiple compressor guide vanes, wherein the multiple compressor guide vanes are coupled with levers, the levers are coupled with an actuating ring which sits on a casing of the compressor and is movable around the circumference of the compressor casing, and the guide vanes are rotatable as the actuating ring moves around the circumference of the compressor casing, the method comprising: measuring the positions of at least two points on the circumference of the actuating ring by at least two linear position sensors fixed on the compressor casing and pointing at the actuating ring vertically at a time when the actuating ring deviates from its original position where the ring center coincides with the casing center; calculating the ring center offset based on the measured positions of the at least two points and the radius of the actuating ring; measuring the angle of one of the multiple guide vane at the same time when measuring the positions of the at least two points; and calculating the angles of all of the multiple guide vanes based on the ring center offset and the angle of the one guide vane.

Another embodiment of the invention is directed to an actuation apparatus for multiple compressor guide vanes, comprising: levers with which the guide vanes are coupled; an actuating ring coupled with the levers which sits on a casing of the compressor for rotating the multiple guide vanes by a circumferential movement; at least two linear position sensors which are fixed on the compressor casing pointing at the actuating ring vertically for measuring the positions of at least two points on the circumference of the actuating ring; a rotary sensor coupled with one of the multiple guide vanes for measuring the angle of the guide vane coupled with the rotary sensor at the same time when the positions of the at least two points are measured; and a controller used for: calculating the ring center offset based on the measured positions of the at least two points and the radius of the actuating ring, and calculating the angles of the multiple guide vanes based on the ring center offset and the angle of the guide vane.

Another embodiment of the invention is directed to an actuation apparatus for multiple compressor guide vanes, comprising: levers with which the guide vanes are coupled; an actuating ring coupled with the levers which sits on a casing of the compressor and is movable around the circumference of the compressor casing for rotating the multiple guide vanes; at least two linear position sensors which are fixed on the compressor casing pointing at the actuating ring vertically for measuring the positions of at least two points on the circumference of the actuating ring; and a controller used for: calculating the ring center offset based on the measured positions of the at least two points and the radius of the actuating ring, and calculating the maximum vane angle deviation based on the ring center offset.

### BRIEF DESCRIPTION OF THE DRAWINGS

FIG. 1 is a schematic illustration of an actuation apparatus for multiple guide vanes in one embodiment of the invention.

FIG. 2 is a partial flow diagram of a method for determining the angular positions of multiple compressor guide vanes of FIG. 1.

FIG. 3 is a schematic illustration showing the position deviation of the actuating ring in one embodiment of the invention.

FIG. 4 is a partial flow diagram of a first method for determining the angle deviation of multiple compressor guide vanes of FIG. 1.

FIG. 5 is a partial flow diagram of a second method for determining the angle deviation of multiple compressor guide vanes of FIG. 1.

FIG. 6 is a partial flow diagram of a method for controlling the angular positions of multiple compressor guide vanes of FIG. 1.

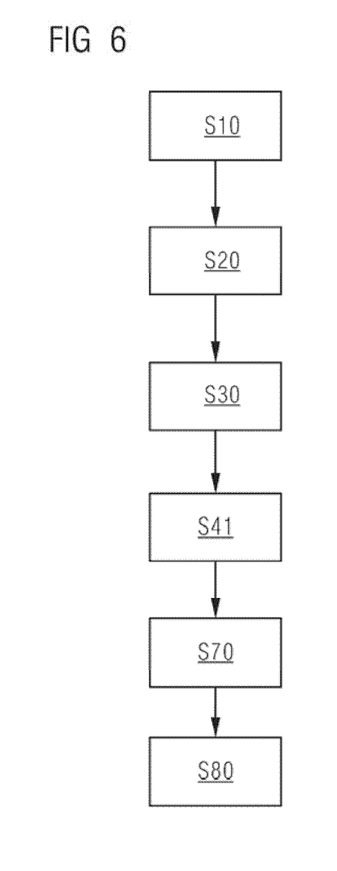

### DETAILED DESCRIPTION OF THE EXAMPLE EMBODIMENTS

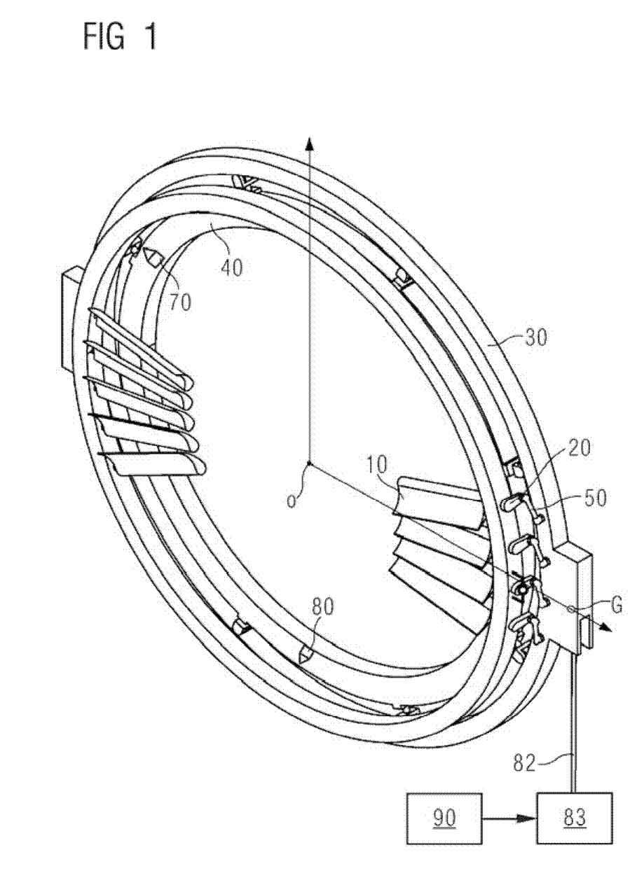

FIG. 1 is a schematic illustration of an actuation apparatus for multiple guide vanes in one embodiment of the invention. It will be recognized that embodiments of the invention may be used with various gas turbine, steam turbine, hydro turbines or other turbo machinery. A gas turbine is used in the following part of this description as an example to show aspects of the inventions. Different angular positions of compressor guide vanes correspond to different loads of gas turbines. For instance, when the load of a gas turbine is smaller than 80%, its guide vanes stay at a predetermined set point, an opening angle of 57°. The opening angles of the guide vanes are modulated gradually to another predetermined set point 84°, as the load rises to 100%. An actuation apparatus is used to drive the compressor guide vanes and modulate their angular positions for the purpose of adapting to the change of working conditions of gas turbines.

As shown in FIG. 1, the compressor has a casing 40 accommodating the actuation apparatus. An actuating ring 30 is an annular piece for actuating the multiple guide vanes 10 when a pushrod 82 actuates the actuating ring 30 to move around the circumference of the compressor casing 40. The actuating ring 30 may be a synchronic ring which is widely used in gas turbines. The actuating ring 30 sits on the compressor casing 40 via bearings 86. The compressor casing 40 and the actuating ring 30 are concentrically assembled. Namely, the ring center coincides with the casing center when the actuating ring 30 is at its original position where no eccentricity takes places. A row of guide vanes 10 with pivot pins is coupled with one ends of first levers 20 via the pivot pins. The guide vanes 10 are rotatable about their pivot pins when actuated by the actuating ring 30 through second levers 50. The actuating ring 30 is coupled with the second levers 50.

When the pushrod 82 is actuated by a driving motor 83, the pushrod 82 drives the actuating ring 30 to move around the circumference of the compressor casing 40, the actuating ring 30 then moves the first levers 20 and the second levers 50, and then the first levers 20 drive the guide vanes 10 to change the angular positions thereof. Eccentricity of the actuating ring 30 occurs when the pushrod 82 drives the actuation ring 30 by imposing forces on it.

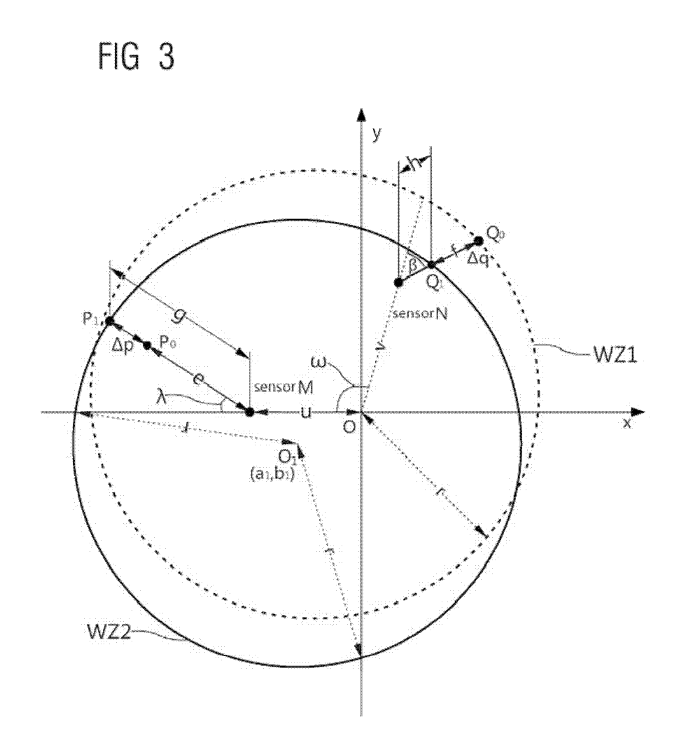

FIG. 3 is a schematic illustration showing the position deviation of the actuating ring in one embodiment of the invention. Two linear position sensors 70, 80 are fixed at any points M, N on the compressor casing 40. Specifically speaking, one ends of the position sensors 70, 80 are fixed on the compressor casing 40, which means that the position sensors 70, 80 cannot move, as the actuating ring 30 moves around the circumference of the compressor casing 40. That is to say, the angle A of the position sensor 70, which is shown in FIG. 3, is constant. The other ends of the position sensors 70, 80 are not fixed, for instance on the actuating ring 30. Besides, the position sensors 70, 80 are arranged so as to point at the actuating ring 30 vertically for measuring the positions of points P₀, Q₀ and P₁, Q₁ on the circumference of the actuating ring 30. Making the position sensors 70, 80 point to the actuation ring 30 vertically is to ensure that the position sensors 70, 80 and the actuation ring 30 stay at the same vertical plane for the purpose of simplifying the measurement of the angular positions of the guide vanes.

The linear position sensors 70, 80 may be linear ultrasonic sensors, laser distance sensors and thimble type sensors. In one embodiment of the invention, two laser distance sensors 70, 80 are used. One ends of the laser distance sensors 70, 80 is fixed to two points M and N on the compressor casing 40 and point to the actuation ring 30 vertically, whereas the other ends of the laser distance sensors 70, 80 is not fixed. For instance, ultrasonic sensors and laser distance sensors are fixed merely on the compressor casing 40, not on the actuating ring 30. As shown in FIG. 3, the laser distance sensors 70, 80 transmit laser beams onto two points P₀, Q₀ on the surface of the actuating ring 30, when the actuating ring 30 is at its original position WZ1 where the original ring center O coincides with the casing center. In this way, the position sensors 70, 80 can determine the distance e and f. Then, the actuating ring 30 moves to a position WZ2 under a force with the ring center moving to O1 which deviates from the original ring center O. At this time, the position sensors 70, 80 may be operated to transmit laser beams onto another two points P₁, Q₁ on the surface of the actuating ring 30. It can be seen that the three points P₀, P₁ and M are in the same line and the three points Q₀, Q₁ and N are in the same line.

It should be noted that although two linear position sensors 70, 80 are illustrated in FIGS. 1 and 3, more linear position sensors, such as three and four, can be used. Correspondingly, the positions of more points than points P₁, Q₁ on the actuating ring 30 can be measured.

In another embodiment of the invention, two linear thimble type sensors 70, 80 may be used. One ends of the thimble type sensors 70, 80 are fixed on the compressor casing 40 and the other ends of the linear thimble type sensors 70, 80 contact the surface of the actuating ring 30, instead of being fixed on the actuating ring 30.

A rotary sensor 60, such as a rotary transducer, is coupled with any one of the multiple guide vanes 10 for measuring the angle aₓ of the guide vane. In one embodiment of the invention, the rotary sensor 60 may be fastened to one guide vane by crews.

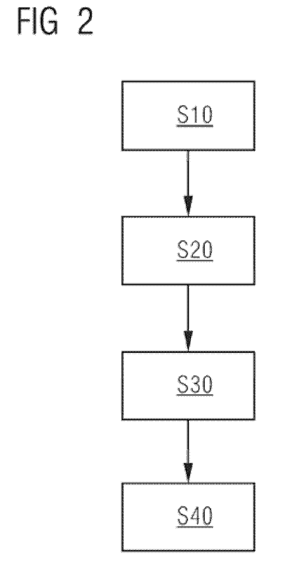

FIG. 2 shows a partial flow diagram of a method for determining the angular positions of multiple compressor guide vanes, according to one aspect of the invention. In S10 the method measures the positions of two points, e.g. points P₁, Q₁ on the circumference of the actuating ring 30 in the direction to which the two linear position sensors 70, 80 point at a time when the actuating ring 30 deviates from its original position.

Then, in S20 the method calculates the ring center offset a₁, b₁ based on the measured positions of the two points P₁, Q₁ and the radius r of the actuating ring 30. Explanations and details about this step are as follows.

The original position WZ1 in FIG. 1 is where the actuating ring 30 is at its original position, whereas the deviated position WZ2 is where the actuating ring 30 deviates from its original position under the forces of the pushrod 82. The two position sensors 70, 80 are fixed respectively at point M and point N on the compressor casing 40.

The positions of the two position sensors 70, 80 can be calibrated when the actuating ring 30 is at the original position WZ1. Laser distance sensors 70, 80 are used as an example to present the method according to one aspect of the invention. The Laser distance sensors 70, 80 transmit laser beams onto two points P₀, Q₀ on the surface of the actuating ring 30, when the actuating ring 30 is at its original position WZ1. In this way, the position sensors 70, 80 can measure the distance e between point M and point P0 and distance f between point N and point Q₀. The angle λ of the first position sensor 70 is constant. Once the positions of the position sensors 70, 80 are located, the direction of the first axis X can be defined. The direction of the axis X points from the casing center to the point M, where the first position sensor 70 is located. λ is the angle between the sensor pointing direction and the connecting line between the first position sensor 70 and the casing center. The direction of the second axis Y which is perpendicular to the first axis X can also be defined. A Cartesian coordinate system is thus defined. A skilled person can understand that non-horizontal axis X can be used in this invention, although axis X is horizontal in FIG. 3. The angle β between ON and NQ₀ can be measured. The angle ω between the two position sensors 70, 80 can also be measured.

During the operation of the compressor, the pushrod 82 imposes forces on the actuating ring 30 and causes it to deviate from its original position WZ1 to position WZ2. The Laser distance sensors 70, 80 can be operated to transmit laser beams onto two points P₁, Q₁ on the surface of the actuating ring 30 which deviates from its original position WZ1. In this way, the position sensors 70, 80 can measure the distance g between point M and point P₁ and h between point N and point Q₁.

The ring center offset a₁, b₁ at position WZ2 in the Cartesian coordinate system can be derived with various formulas using the trigonometric functions among the measured parameters. Two examples are presented below to show the formulas.

### EXAMPLE 1

a₁=f₁(r, e, ω, Δp, Δq, λ, β, f)

b₁=f₂(r, e, ω, Δp, Δq, λ, β, f)

Specifically speaking,

$$\begin{matrix}{( - γ \cdot cos [ arcsin ( \frac{e}{r} \cdot sin ( π - λ ) ) ] - Δ ϕ \cdot cos λ - {a}_{\text{?}} )}^{\text{?}} + {( \text{?} \cdot sin ( n - λ ) + Δ p \cdot sin λ - \text{?} )}^{2} \text{?} \text{?} & ( 1 ) \\ {( \text{?} \cdot cos [ π - \text{?} - arcsin ( \frac{f}{r} \cdot sin ( π - β ) ) ] + Δ ϕ \cdot cos ( π - ω - β ) - \text{?} )}^{\text{?}} + {( \begin{matrix}r \cdot sin [ π - ω - arcsin ( \frac{f}{r} \cdot sin ( π - β ) ) ] + \\ Δ ϕ \cdot sin ( π - ω - β ) - \text{?}\end{matrix} )}^{2} = {r}^{2} \\ \text{?} \text{indicates text missing or illegible when filed} & ( 2 )\end{matrix}$$

In equation (1) and (2) above:
r is the radius of the actuating ring 30, which can be measured ahead of time;
e is the distance between point M and point P0;
ω is the angle between the two sensors 70, 80;
Δp=g−e and Δq=f−h;
g is the distance between point M and point P₁;
h is the distance between point N and point Q₁;
f is the distance between point N and point Q₀;
λ is the angle of the position sensor 70; and
β is the angle between ON and NQ₀.

### EXAMPLE 2

a₁=f₃(r, g, ω, u, v, λ, β, h)

b₁=f₄(r, g, ω, u, v, λ, β, h)

Specially speaking,

[−(u+g·cos λ)−a₁]²+[g·sin λ−b₁]²=r² (3)

[cos(π−ω)·v+cos(π−ω−β}·h−a₁]²+[sin(π−ω)·v+sin(π−ω−β)·h−b₁]²=r² (4)

In equations (3) and (4) above, as shown in FIG. 3,
r is the radius of the actuating ring 30, which can be measured ahead of time;
g is the distance between point M and point P₁;
ω is the angle between the two sensors 70, 80;
u is the distance between the original ring center O and the point M where the position sensor 70 lies;
v is the distance between the original ring center O and the point N where the position sensor 80 lies;
λ is the angle of the position sensor 70;
h is the distance between point N and point Q₁;
f is the distance between point N and point Q₀;
e is the distance between point M and point P₀;
Δp=g−e and Δq=f−h; and
β is the angle between ON and NQ₀.

In S30, the method measures the angle of one of the multiple guide vane αₓ at the same time when measuring the positions of two points P₁, Q₁ with the rotary sensor 60. The rotary sensor 60 may be fastened to one guide vane 10 by crews.

Then, in S40 the method calculates the angles of some or all of the multiple guide vanes αi based on the ring center offset a₁, b₁ and the angle of the guide vane αₓ. The angles of some of the multiple guide vanes may be calculated for some purposes, while the angles of all of the multiple guide vanes may be calculated for other purposes.

aᵢ=f(a₁, b₁, θₓ, αₓ, θᵢ l₁) (5)

In equation (5) above:
a₁, b₁ is the ring center offset;
θₓ is the angle of the guide vane on the circumference of compressor casing 40 in the defined Cartesian coordinate system. This guide vane is the one whose position angle is measured by the rotary sensor 60;
θᵢ is the angle of any guide vane on the circumference of compressor casing 40 in the defined Cartesian coordinate system; i may be 1, 2, 3, 4 . . . indicating any of the multiple guide vanes 10.
aₓ is the position angle of the guide vane measured by the rotary sensor 60;
l₁ is the length of the first levers 20 connecting the guide vanes.

For a certain frame of compressor, only two parameters, the ring center offset a₁, b₁ and the position angle α₁ of the guide vane measured by the rotary sensor 60, vary with time. The other parameters in equation (5) are constant.

A skilled person can obtain the specific function f in equation (5) whose variables are the ring center offset a₁, b₁ and the position angle αi of the guide vane according to kinematics analysis.

An exemplary function is:

$$\{ \begin{matrix}{α}_{i} = {α}_{x} + \frac{\sqrt{{a}_{1}^{2} + {b}_{1}^{2}}}{{l}_{1}} [ cos ( {θ}_{i} + {θ}_{d} ) - cos ( {θ}_{x} + {θ}_{d} ) ] \\ {θ}_{d} = \{ \begin{matrix}a tan ( {a}_{1} / {b}_{1} ) & if ( {a}_{1} \geq 0 , {b}_{1} \geq 0 , ) \\ a tan ( {a}_{1} / {b}_{1} ) + π & if ( {a}_{1} < 0 , {b}_{1} > 0 , ) \\ a tan ( {a}_{1} / {b}_{1} ) + π & if ( {a}_{1} < 0 , {b}_{1} < 0 , ) \\ a tan ( {a}_{1} / {b}_{1} ) + 2 π & if ( {a}_{1} > 0 , {b}_{1} < 0 , )\end{matrix}\end{matrix}$$

In equations (6) above, θ_{d} is the actuating ring offset direction angle with reference to axis X at the time when the positions of the two points P₁, Q₁ are measured, that is the angle between line OO1 and axis X. This actuating ring offset direction angle θ_{d} can be calculated based on a₁, b₁, as can be seen from equations (6). θᵢ is the angle of any guide vane on the circumference of compressor casing 40 in the defined Cartesian coordinate system; ax is the position angle of the guide vane measured by the rotary sensor 60.

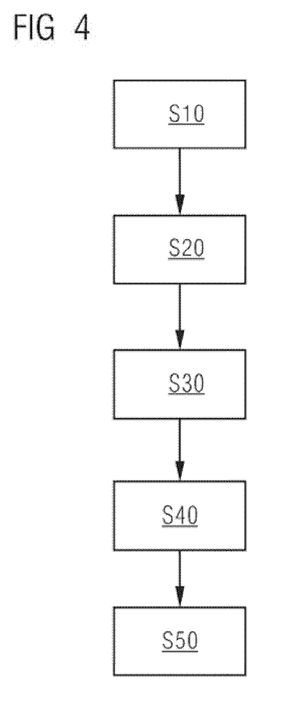

A first method for determining the angle deviation of multiple compressor guide vanes is presented according to an aspect of the invention. FIG. 4 is a partial flow diagram of this method. In addition to step S10, S20, S30 and S40 stated above, this method further includes step S50: calculating the differential of the maximum angle αmax and the minimum angle αmin of the multiple guide vanes as the maximum vane angle deviation maxΔα.

Namely,

maxΔα=αmax−αmin (7)

The maximum angle αₘₐₓ and the minimum angle αₘᵢₙ can be selected from the calculated angles of the multiple guide vanes.

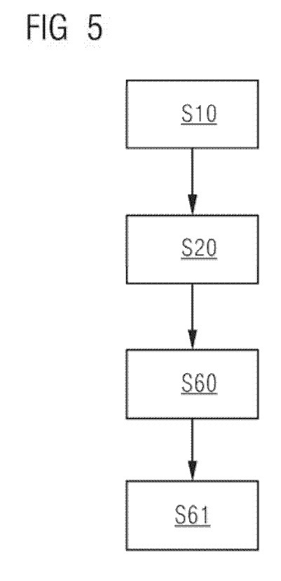

A second method for determining the angle deviation of multiple compressor guide vanes is presented according to an aspect of the invention. FIG. 5 is a partial flow diagram of a second method. In addition to step S10 and S20 stated above, this method further includes S60: calculating the maximum vane angle deviation maxΔα based on the calculated ring center offset a₁, b₁.

$$max Δ α = \frac{2 \sqrt{{a}_{1}^{2} + {b}_{1}^{2}}}{{l}_{1}} \qquad ( 8 )$$

Where a₁, b₁ is the ring center offset, and
l₁ is the length of the first levers 20 connected with the guide vanes.

In one embodiment of the invention, a method for determining the angle deviation of multiple compressor guide vanes further comprises step S61: determining whether the maximum vane angle deviation maxΔα is damaging to the compressor by comparing the maximum vane angle deviation maxΔα with a set threshold.

A method for controlling the angular positions of multiple compressor guide vanes 10 is presented according to one aspect of the invention. In addition to S10, S20 and S30, stated above, this method further includes step S41: calculating the angles of all of the multiple guide vanes αi at the time when measuring the positions of two points P₁, Q₁, based on the ring center offset a₁, b₁ and the angle of the guide vane αₓ.

This method also includes step S70: obtaining the average αₐᵥₑ of the angles of all the multiple guide vanes αᵢ; and step S80 using the average αₐᵥₑ as feedback for modulating the angles of the guide vanes 10. The average αₐᵥₑ of the angles of the multiple guide vanes αᵢ can be calculated at regular intervals. The average αₐᵥₑ of all the angles of all the multiple guide vanes αᵢ accurately represents the angular positions of all the multiple guide vanes. The close-loop control method using the average αₐᵥₑ as feedback to is enabled to reduce vane-vane deviation.

An actuation apparatus for multiple compressor guide vanes is presented according to one aspect of the invention. The actuation apparatus comprises: levers 20 with which the guide vanes 10 are couple; an actuating ring 30 coupled with the levers 20 which sits on the compressor casing 40 for rotating the multiple guide vanes 10; two linear position sensors 70, 80 which are fixed on the compressor casing 40 pointing at the actuating ring 30 vertically for measuring the positions of two points P₁, Q₁ on the circumference of the actuating ring 30; a rotary sensor 60 coupled with one of the multiple guide vanes 10 for measuring the angle αₓ of the guide vane coupled with the rotary sensor 60 at the same time when the positions of the two points P₁, Q₁ are measured; and a controller 90 which may be programmed for calculating the ring center offset a₁, b₁ based on the measured positions of the two points P₁, Q₁ and the radius r of the actuating ring 30, and for calculating the angles of the multiple guide vanes αi based on the ring center offset a₁, b₁ and the angle of the guide vane αₓ.

In one embodiment of the invention, the controller 90 may further be programmed for obtaining the average αₐᵥₑ of the angles of the multiple guide vanes αᵢ; and using the average αₐᵥₑ as feedback for controlling the angles of the guide vanes 10.

In one embodiment of the invention, the controller 90 may be further programmed for calculating the differential of the maximum angle and the minimum angle of the multiple guide vanes as maximum vane angle deviation maxΔα as.

In one embodiment of the invention, the controller 90 may be further programmed for determining whether the maximum vane angle deviation maxΔα is damaging to the compressor by comparing the maximum vane angle deviation maxΔα with a set threshold.

In one embodiment of the invention, the controller 90 uses the following function to calculate the angles of the multiple guide vanes αi based on ring center offset a₁, b₁ and the measured angle of the guide vane αₓ.

$$\{ \begin{matrix}{α}_{i} = {α}_{x} + \frac{\sqrt{{a}_{1}^{2} + {b}_{1}^{2}}}{{l}_{1}} [ cos ( {θ}_{i} + {θ}_{d} ) - cos ( {θ}_{x} + {θ}_{d} ) ] \\ {θ}_{d} = \{ \begin{matrix}a tan ( {a}_{1} / {b}_{1} ) & if ( {a}_{1} \geq 0 , {b}_{1} \geq 0 , ) \\ a tan ( {a}_{1} / {b}_{1} ) + π & if ( {a}_{1} < 0 , {b}_{1} > 0 , ) \\ a tan ( {a}_{1} / {b}_{1} ) + π & if ( {a}_{1} < 0 , {b}_{1} < 0 , ) \\ a tan ( {a}_{1} / {b}_{1} ) + 2 π & if ( {a}_{1} > 0 , {b}_{1} < 0 , )\end{matrix}\end{matrix}$$

In equations (6) above, θ_{d} is the actuating ring offset direction angle with reference to axis X at the time when the positions of the two points P₁, Q₁ are measured, that is the angle between line OO1 and axis X. This actuating ring offset direction angle θ_{d} can be calculated based on a₁, b₁, as can be seen from equations (6).

The controller 90 may be in the form of a processor or computer executable program to implement the functions stated above. Alternatively, the controller 90 may be an analog control system developed with FPGA (Field Programmable Gate Array, ASIC (Application Specific Integrated Circuit) or similar circuits, or other device for receiving input signals or data packets, processing data, executing instructions, producing appropriate output signals. The analog control system is configured with appropriate control modules and databases to execute various functions of the controller 90. The controller 90 may be part of a central control station or a dedicated controller for the actuation apparatus.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A method for determining the angular positions of multiple compressor guide vanes, the multiple compressor guide vanes being coupled with levers, the levers being coupled with an actuating ring sitting on a casing of a compressor and movable around a circumference of the compressor casing, the multiple compressor guide vanes being rotatable as the actuating ring moves around the circumference of the compressor casing, the method comprising:
measuring positions of at least two points on a circumference of the actuating ring, via at least two linear position sensors fixed on the compressor casing and pointing at the actuating ring vertically, at a time when the actuating ring deviates from its original position where a ring center coincides with a center of the casing;
calculating a ring center offset based on the measured positions of the at least two points and a radius of the actuating ring;
measuring an angle of one of the multiple compressor guide vanes at a same time as the measuring of the positions of the at least two points; and
determining the angular positions of the multiple guide vanes based on the calculated ring center offset and the measured angle of the one multiple compressor guide vane.

2. The method according to claim 1, wherein
the levers include the first levers, one end of the first levers being coupled with the guide vanes, and the second levers, one end of the second levers being coupled with the actuating ring; and
wherein the following equations are used in the determining of angular positions of the multiple guide vanes based on the calculated ring center offset and the measured angle of one of the multiple compressor guide vanes:
$$\{ \begin{matrix}{α}_{n} = {α}_{x} + \frac{\sqrt{{a}_{1}^{2} + {b}_{1}^{2}}}{{l}_{1}} [ cos ( {θ}_{i} + {θ}_{d} ) - cos ( {θ}_{x} + {θ}_{d} ) ] \\ {θ}_{d} = \{ \begin{matrix}a tan ( {a}_{1} / {b}_{1} ) & if ( {a}_{1} \geq 0 , {b}_{1} \geq 0 , ) \\ a tan ( {a}_{1} / {b}_{1} ) + π & if ( {a}_{1} < 0 , {b}_{1} > 0 , ) \\ a tan ( {a}_{1} / {b}_{1} ) + π & if ( {a}_{1} < 0 , {b}_{1} < 0 , ) \\ a tan ( {a}_{1} / {b}_{1} ) + 2 π & if ( {a}_{1} > 0 , {b}_{1} < 0 , )\end{matrix}\end{matrix}$$
where aₓ is the measured angle of one of the multiple compressor guide vanes;
a₁, b₁ is the ring center offset;
l₁ is a length of the first levers connected with the guide vanes;
θᵢ is the angle of one of the guide vanes on the circumference of compressor casing, wherein i is 1, 2, 3, or 4, indicating one of the multiple guide vanes;
θ_{d} is the actuating ring offset direction angle with reference to axis X at the time when the positions of the two points are measured; and
θₓ is the angle of the one of the multiple guide vanes on the circumference of compressor casing whose angle is measured.

3. A method for determining a maximum vane angle deviation of multiple compressor guide vanes, the multiple compressor guide vanes being coupled with levers, the levers being coupled with an actuating ring sitting on a casing of a compressor and being movable around a circumference of the compressor casing, the multiple compressor guide vanes being rotatable as the actuating ring moves around the circumference of the compressor casing, the method comprising:
measuring positions of at least two points on the circumference of the actuating ring via at least two linear position sensors, fixed on the compressor casing and pointing at the actuating ring vertically, at a time when the actuating ring deviates from an original position where a ring center coincides with a center of the casing;
calculating a ring center offset based on the measured positions of the at least two points and a radius of the actuating ring;
measuring an angle of one of the multiple compressor guide vanes at a same time as the measuring of the positions of the at least two points;
calculating the angles of the multiple guide vanes based on the calculated ring center offset and the measured angle of one of the multiple compressor vanes; and
calculating the maximum vane angle deviation as a differential of a maximum angle of the calculated angles of the multiple guide vanes and a minimum angle of the calculated angles of the multiple guide vanes.

4. A method for determining the maximum vane angle deviation of multiple compressor guide vanes, the multiple compressor guide vanes being coupled with levers, the levers being coupled with an actuating ring sitting on a casing of the compressor and being movable around a circumference of the compressor casing, the multiple compressor guide vanes being rotatable as the actuating ring moves around the circumference of the compressor casing, the method comprising:
measuring the positions of at least two points on the circumference of the actuating ring via at least two linear position sensors, fixed on the compressor casing and pointing at the actuating ring vertically, at a time when the actuating ring deviates from an original position where a ring center coincides with a center of the casing;
calculating a ring center offset based on the measured positions of the at least two points and a radius of the actuating ring;
determining the maximum vane angle deviation based on the calculated ring center offset.

5. The method of claim 3, further comprising:
determining whether the maximum vane angle deviation is damaging to the compressor by comparing the maximum vane angle deviation to a threshold.

6. A method for calculating and using angles of multiple compressor guide vanes, the multiple compressor guide vanes being coupled with levers, the levers being coupled with an actuating ring sitting on a casing of the compressor and being movable around a circumference of the compressor casing, the multiple compressor guide vanes being rotatable as the actuating ring moves around the circumference of the compressor casing, the method comprising:
measuring the positions of at least two points on the circumference of the actuating ring via at least two linear position sensors, fixed on the compressor casing and pointing at the actuating ring vertically, at a time when the actuating ring deviates from an original position where a ring center coincides with a center of the casing;
calculating a ring center offset based on the measured positions of the at least two points and a radius of the actuating ring;
measuring an angle of one of the multiple compressor guide vanes at a same time as the measuring of the positions of the at least two points;
calculating the angles of all of the multiple compressor guide vanes based on the calculated ring center offset and the measured angle of the one of the multiple compressor guide vanes;
obtaining an average of all of the calculated angles of the multiple compressor guide vanes; and
using the obtained average as feedback for modulating the angles of the multiple compressor guide vanes.

7. An actuation apparatus for multiple compressor guide vanes, comprising:
levers, configured to couple the multiple compressor guide vanes;
an actuating ring, coupled with the levers, configured to sit on a casing of the compressor, to rotate the multiple compressor guide vanes by a circumferential movement;
at least two linear position sensors, fixed on the compressor casing, configured to point at the actuating ring vertically, to measure positions of at least two points on a circumference of the actuating ring;
a rotary sensor, coupled with one of the multiple compressor guide vanes, to measure an angle of one of the multiple compressor guide vanes coupled with the rotary sensor, at a same time the measuring of the positions of the at least two points; and
a controller configured to:
calculate a ring center offset based on the measured positions of the at least two points and a radius of the actuating ring, and
calculate the angles of the multiple compressor guide vanes based on the calculated ring center offset and the angle of the one of the multiple compressor guide vanes.

8. The apparatus of claim 7, wherein the controller is further configured to:
obtaining an average of the angles of the multiple compressor guide vanes; and
use the average as feedback to controlling the angles of the multiple compressor guide vanes.

9. The apparatus of claim 7, wherein
the levers include the first levers, one end of the first levers being coupled with the multiple compressor guide vanes and the second levers, one end of the second levers being coupled with the actuating ring; and
the controller is configured to use the following equations to calculate the angles of the multiple compressor guide vanes based on ring center offset and the respective angle of the respective multiple compressor guide vane:
$$\{ \begin{matrix}{α}_{n} = {α}_{x} + \frac{\sqrt{{a}_{1}^{2} + {b}_{1}^{2}}}{{l}_{1}} [ cos ( {θ}_{i} + {θ}_{d} ) - cos ( {θ}_{x} + {θ}_{d} ) ] \\ {θ}_{d} = \{ \begin{matrix}a tan ( {a}_{1} / {b}_{1} ) & if ( {a}_{1} \geq 0 , {b}_{1} \geq 0 , ) \\ a tan ( {a}_{1} / {b}_{1} ) + π & if ( {a}_{1} < 0 , {b}_{1} > 0 , ) \\ a tan ( {a}_{1} / {b}_{1} ) + π & if ( {a}_{1} < 0 , {b}_{1} < 0 , ) \\ a tan ( {a}_{1} / {b}_{1} ) + 2 π & if ( {a}_{1} > 0 , {b}_{1} < 0 , )\end{matrix}\end{matrix}$$
wherein aₓ is the measured angle of the respective multiple compressor guide vane;
a₁, b₁ is the ring center offset;
l₁ is a length of the first levers connected with the multiple compressor guide vanes;
θᵢ is the angle of at least one of the multiple compressor guide vanes on the circumference of compressor casing wherein i indicates any one of the multiple compressor guide vanes;
θ_{d} is the actuating ring offset direction angle with reference to axis X, at a time when the positions of the two points are measured; and
θₓ is the angle of the multiple compressor guide vane on the circumference of compressor casing whose angle is measured.

10. The apparatus of claim 7, wherein the controller is further configured to calculate the differential of a maximum angle and a minimum angle of the multiple compressor guide vanes as a maximum vane angle deviation.

11. The apparatus of claim 10, wherein the controller is further configured to determine whether the maximum vane angle deviation is damaging to the compressor by comparing the maximum vane angle deviation to a threshold.

12. An actuation apparatus for multiple compressor guide vanes, comprising:
levers, configured to couple the multiple compressor guide vanes;
an actuating ring, coupled with the levers, configured to sit on a casing of the compressor and being movable around a circumference of the compressor casing to rotate the multiple compressor guide vanes;
at least two linear position sensors, fixed on the compressor casing pointing at the actuating ring vertically, to measure positions of at least two points on the circumference of the actuating ring; and
a controller configured to:
calculate the ring center offset based on the measured positions of the at least two points and a radius of the actuating ring, and
calculate a maximum vane angle deviation based on the ring center offset.

13. The actuation apparatus of claim 12, wherein the controller is further configured to determine whether the maximum vane angle deviation is damaging to the compressor by comparing the maximum vane angle deviation to a threshold.

14. The method of claim 4, further comprising:
determining whether the maximum vane angle deviation is damaging to the compressor by comparing the maximum vane angle deviation to a threshold.
